(19) United States
(12) Patent Application Publication
(10) Pub. No.: US 2006/0036784 A1
(43) Pub. Date: Feb. 16, 2006

(54) Mobile image retrieving and storing device

(76) Inventor: Fok-Kei Loo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/914,174

(22) Filed: Aug. 10, 2004

(51) Int. Cl. G06F 13/12

(52) U.S. Cl. 710/62

(57) ABSTRACT

A mobile image retrieving and storing device mainly comprises a USB hub circuit with a plurality of USB transferring interface units inside and a flash memory circuit with a USB transferring unit therein. The flash memory circuit is connected to the USB hub circuit and a digital camera circuit by the USB transferring interface; a USB transferring unit is in the digital camera circuit, and the digital camera circuit is connected to the USB hub circuit by the USB transferring interface. The characteristic of the present invention is to integrate the digital camera circuit and the flash memory circuit into one device by an expanding USB transferring interface.

### BACKGROUND OF THE INVENTION

1. Field of the Invention

A mobile image retrieving and storing device integrates a USB hub circuit, a flash memory circuit and a digital camera circuit into one device.

2. Description of Related Art

Digital cameras replace the prior art cameras as popular products in recent years; internal circuits of digital cameras are complicated. A variety of memory cards are used as image storage devices instead of digital cameras.

USB hubs are used in wired-internet products and designed for local area networks; thus, more clients can be connected to a server.

A USB flash driver is used in common flash disks for accessing data conveniently.

The USB hub can expand a USB transferring interface, therefore, the present invention provides a mobile image retrieving and storing device to integrate a digital cameras and a flash memory circuit into one device.

### SUMMARY OF THE INVENTION

The object of the present invention is to integrate a digital camera circuit and a flash memory circuit into one device by an expanding USB transferring interface.

The present invention mainly comprises a USB hub circuit with a plurality of USB transferring interface units inside and a flash memory circuit with a USB transferring unit therein. The flash memory circuit is connected to the USB hub circuit and a digital camera circuit by the USB transferring interface; a USB transferring unit is in the digital camera circuit, and the digital camera circuit is connected to the USB hub circuit by the USB transferring interface.

The various objects and advantages of the present invention will be more readily understood from the following detailed description when read in conjunction with the appended drawing, in which:

### BRIEF DESCRIPTION OF THE DRAWINGS

FIG. 1 shows a perspective view of the present invention;

FIG. 2 shows a block diagram of the internal structure of the present invention;

FIG. 3 shows a first embodiment of the present invention; and

FIG. 4A and FIG. 4B show a second embodiment of the present invention.

### DETAILED DESCRIPTION OF PREFERRED EMBODIMENTS

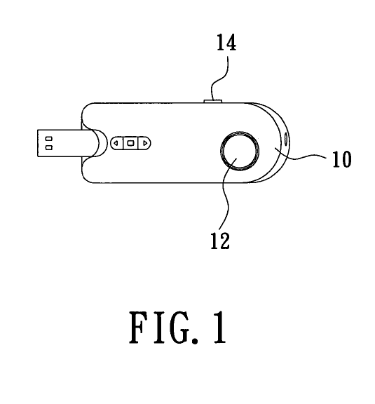

FIG. 1 shows a perspective of the mobile image retrieving and storing device, which comprises a shell 10, a camera lens 12 and a button 14. Users can take images through the camera lens 12 and then the images will be stored into a flash memory (not labeled) in the device.

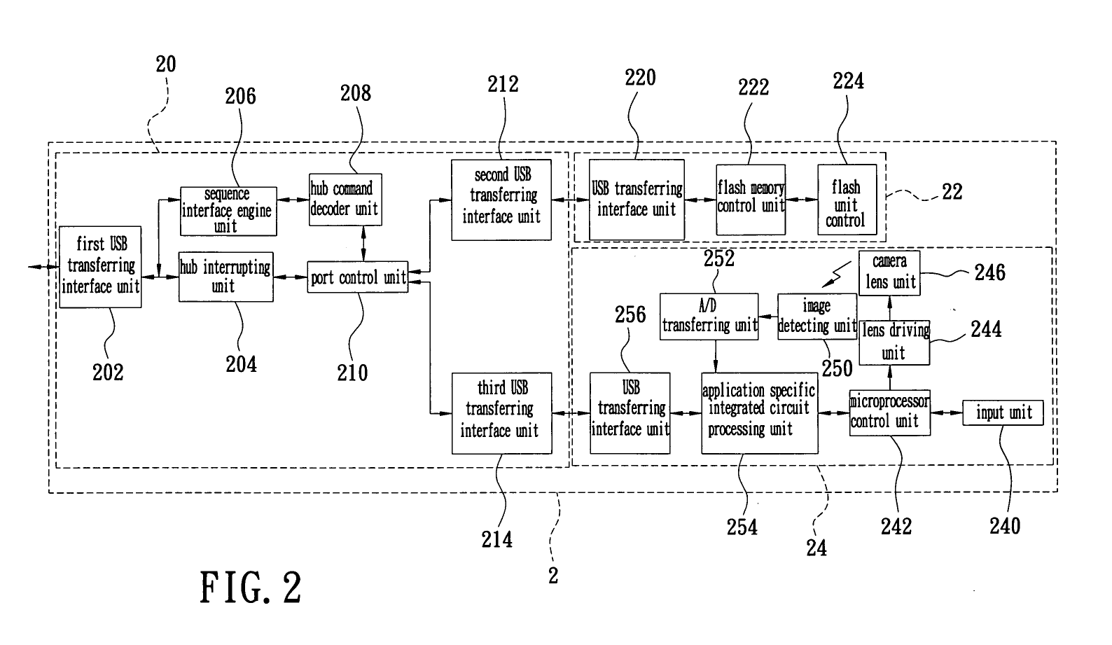

Please refer FIG. 2, it shows an internal structure block diagram of the present invention, which includes a USB hub internal circuit 20, a flash memory internal circuit 22 and a digital camera internal circuit 24.

The USB hub internal circuit .20 comprises a first USB transferring interface unit 202, a hub interrupting unit 204, a sequence interface engine unit 206, a hub command decoder unit 208, a port control unit 210, a second USB transferring interface unit 212, and a third USB transferring interface unit 214.

Wherein the hub command decoder unit 208 receives signals of the port control unit 210 and decodes the signals into commands; the commands are sent to the sequence interface engine unit 206 and the hub interrupting unit 204.

The flash memory internal circuit 22 comprises a USB transferring interface unit 220, a flash memory control unit 222, and a flash memory unit 224.

The digital camera internal circuit 24 comprises an input unit 240, a microprocessor control unit 242, a lens driving unit 244, a camera lens unit 246, an image detecting unit 250, an A/D transferring unit 252, an application specific integrated circuit (ASIC) processing unit 254, and a USB transferring interface unit 256.

The microprocessor control unit 242 receives signals of the input unit 240 and sends the signals to the lens driving unit 244 to control the camera lens unit 246 for taking analog images. The analog images are sent to the image detecting unit 250 and transformed into digital images for the application specific integrated circuit processing unit 254.

The application specific integrated circuit processing unit 254 receives signals from the A/D transferring unit 252 and the microprocessor control unit 242. The digital images are transferred to the port control unit 210 through the USB transferring interface unit 256. The digital images are stored into the flash memory unit 224 by the commands from the hub command decoder unit 208.

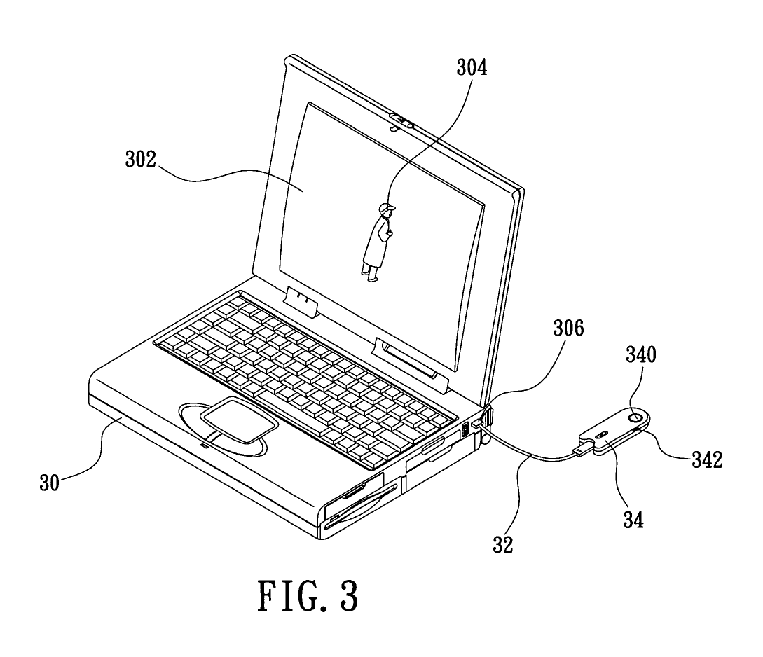

FIG. 3 shows a first embodiment of the present invention, it comprises a notebook 30, a display 302, an image 304, a USB interface 306, a USB connecting line 32, a shell 34, a camera lens 340, a button 342.

In the first embodiment, the USB interface 306 is connected to the notebook 30 through a USB connecting line 32. The button 342 can be pressed to take the image 304 of the user for editing the address book in the notebook 30, and the display 302 shows the image 304.

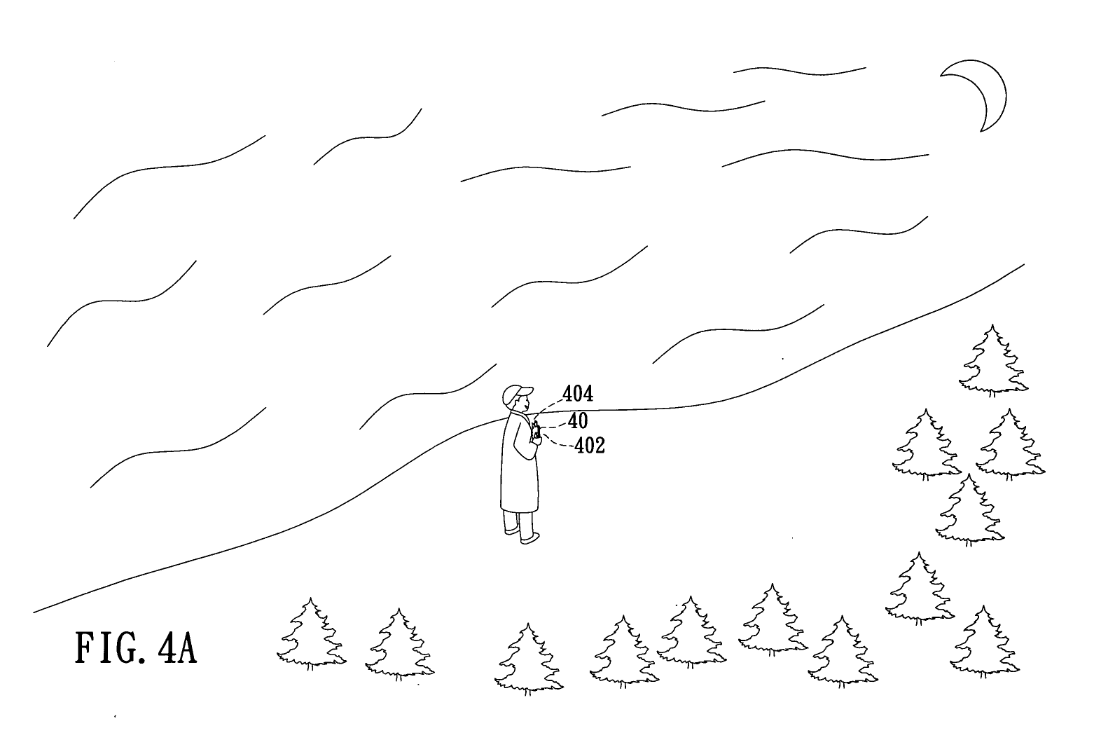

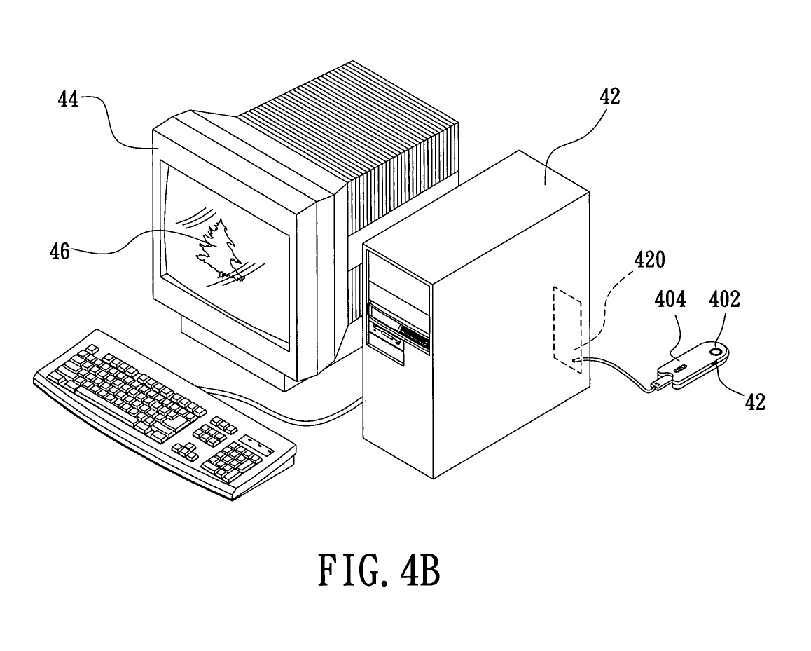

FIG. 4A and FIG. 4B shows a second embodiment of the present invention, it includes a shell 40, a camera lens 402, a button 404, a computer host 42, a USB interface 420, a display 44 and an image 46.

In the second embodiment, user can store the images 46 into a flash memory unit (not labeled) of a flash memory circuit. The present invention is connected to the USB interface 420 of the computer host 42 by a USB connecting line 32. The images 46 is transferred to the computer host 42 and shown by the display 44.

The characteristic of the present invention is to integrate a digital camera circuit and a flash memory circuit into one device by an expanding USB transferring interface.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

What is claimed is:

1. A mobile image retrieving and storing device, comprising:
a USB hub circuit with a plurality of USB transferring interface units therein; and
a flash memory circuit with a USB transferring unit therein;
wherein the flash memory circuit is connected to the USB hub circuit and a digital camera circuit by the USB transferring interface; a USB transferring unit is in the digital camera circuit, and the digital camera circuit is connected to the USB hub circuit by the USB transferring interface; the characteristic of the present invention is to integrate a digital camera circuit and a flash memory circuit into one device by an expanding USB transferring interface.

2. A mobile image retrieving and storing device as in claim 1, wherein the USB hub circuit further comprises:
a first USB transferring interface unit connected to an external USB device;
a second USB transferring interface unit connected to the flash memory circuit by the USB transferring interface;
a third USB transferring interface unit connected to the digital camera circuit by the USB transferring interface;
a hub interrupting unit;
a sequence interface engine unit;
a port control unit; and
a hub command decoder unit receiving signals of the port control unit and decoding the signals into commands for the sequence interface engine unit and hub interrupting unit.

3. A mobile image retrieving and storing device as in claim 2, wherein the port control unit receives the commands from the hub command decoder unit to control a plurality of USB transferring ports.

4. A mobile image retrieving and storing device as in claim 2, wherein the hub interrupting unit receives the commands from the hub command decoder unit for interruption.

5. A mobile image retrieving and storing device as in claim 2, wherein the sequence interface engine unit receives signals of the hub interrupting unit, and a specific USB transferring port is driven by the commands from the hub command decoder unit.

6. A mobile image retrieving and storing device as in claim 1, wherein the flash memory further comprises:
a USB transferring interface unit;
a flash memory control unit; and
a flash memory unit.

7. A mobile image retrieving and storing device as in claim 1, wherein the digital camera circuit further comprises:
an input unit;
a microprocessor control unit receiving signals of the input unit and performing a specific action;
a lens driving unit receiving signals of the microprocessor control unit and performing a corresponding action;
a camera lens unit receiving signals of the lens driving unit and taking images;
an image detecting unit sensing analog optical signals of the camera lens unit;
an A/D transferring unit transforming the analog optical signals into digital signals;
a USB transferring interface unit; and
an application specific integrated circuit processing unit receiving signals from the A/D transferring unit and the microprocessor control unit, and the digital signals are transferred through the USB transferring interface unit.
